(19) United States
(12) Patent Application Publication
(10) Pub. No.: US 2013/0141954 A1
(43) Pub. Date: Jun. 6, 2013

(54) POWER SUPPLY CIRCUIT

(71) Applicants: TE-MING CHANG, Tu-Cheng (TW); KUO-HSIANG CHANG, Tu-Cheng (TW)

(72) Inventors: TE-MING CHANG, Tu-Cheng (TW); KUO-HSIANG CHANG, Tu-Cheng (TW)

(73) Assignee: HON HAI PRECISION INDUSTRY CO., LTD., Tu-Cheng (TW)

(21) Appl. No.: 13/450,746

(22) Filed: Apr. 19, 2012

(30) Foreign Application Priority Data
Dec. 6, 2011 (TW) 100144952

(51) Int. Cl. H02M 7/04

(52) U.S. Cl. 363/84

(57) ABSTRACT

A power supply circuit includes an alternating current to direct current (AC/DC) converter, an uninterruptible power supply (UPS), a protection circuit, and a power supply unit (PSU). The AC/DC converter converts AC power from the UPS to DC power and transmits the DC power to the PSU through the protection circuit. The protection circuit includes a first resistor, a first switch, a first capacitor, and a microprocessor. At the initial time when the UPS first supplies power to the UPS, the microprocessor turns off the first switch; after a preset time has elapsed, the microprocessor turns on the first switch.

### BACKGROUND

1. Technical Field

The present disclosure relates to a power supply circuit.

2. Description of Related Art

In servers, uninterrupted power supplies (UPS) are almost always used to power the servers. When external power supplies cease outputting voltage to the servers, the UPS will supply power to the servers. However, because of capacitors used in power supply circuits in the servers, surge currents may occur during the switch over from the external power supplies to the UPS, such that the servers may be damaged.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of a first embodiment of a power supply circuit.

FIG. 2 is a block diagram of a second embodiment of a power supply circuit.

FIG. 3 is a block diagram of a third embodiment of a power supply circuit.

FIG. 4 is a block diagram of a fourth embodiment of a power supply circuit.

FIG. 5 is a block diagram of a fifth embodiment of a power supply circuit.

FIG. 6 is a block diagram of a sixth embodiment of a power supply circuit.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

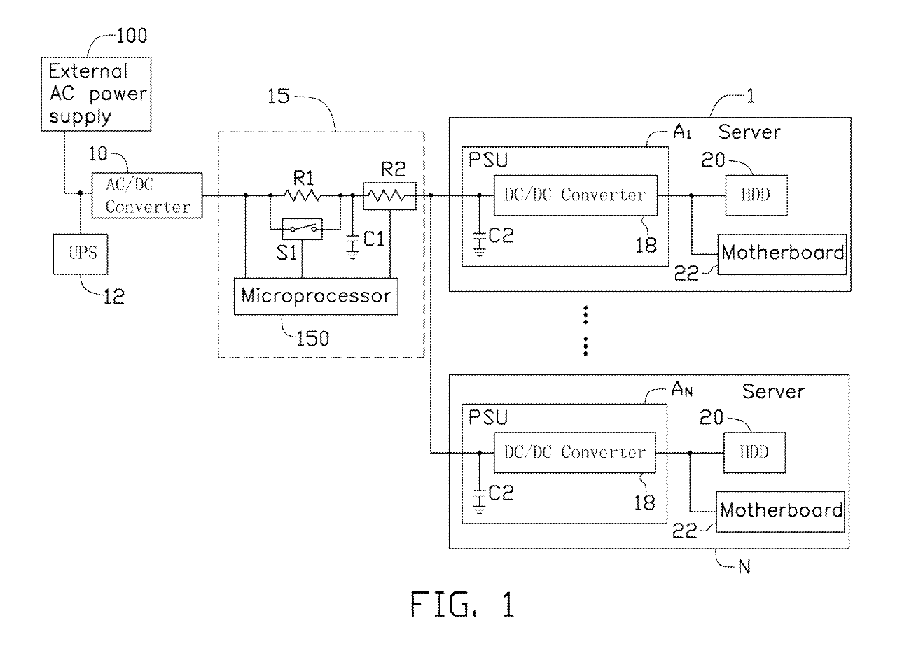

Referring to FIG. 1, a power supply circuit supplies power to a plurality of servers 1-N. A first embodiment of the power supply circuit includes an alternating current to direct current (AC/DC) converter 10, an uninterruptible power supply (UPS) 12, a protection circuit 15, N power supply units (PSUs) A1-AN. Each PSU is located inside a corresponding server for supplying power to the server.

The AC/DC converter 10 is connected to an external AC power supply 100 for converting the AC power to DC power, and transmitting the DC power to the PSUs A1-AN through the protection circuit 15. The UPS 12 is connected to the AC/DC converter 10 for supplying power to the servers 1-N when the external AC power supply 100 does not output voltage to the servers 1-N.

The protection circuit 15 includes a resistor R1, a switch S1, a capacitor C1, a current sensing resistor R2, and a microprocessor 150. Each PSU includes a DC to DC (DC/DC) converter 18 and a capacitor C2.

A first terminal of the resistor R1 is connected to the AC/DC converter 10. A second terminal of the resistor R1 is connected to the PSUs A1-AN through the current sensing resistor R2. A node between the resistor R1 and the current sensing resistor R2 is grounded through the capacitor C1. The switch S1 is connected with the resistor R1 in parallel. A voltage sensing terminal of the microprocessor 150 is connected to the first terminal of the resistor R1. A current sensing terminal of the microprocessor 150 is connected to the current sensing resistor R2. A control terminal of the microprocessor 150 is connected to the switch S1. The capacitor C1 filters current from the AC/DC converter 10.

The DC/DC converter 18 receives voltage outputted from the protection circuit 15, and converts the voltage to other voltages with different values for supplying power to components in servers, such as hard disk drivers (HDDs) 20 and motherboards 22. A node between the protection circuit 15 and the DC/DC 18 converter is grounded through the capacitor C2.

The microprocessor 150 measures voltage received by the protection circuit 15. When the voltage received by the protection circuit 15 is greater than zero, the microprocessor 15 will determine whether it is the external AC power supply 100 or the UPS 12 which will supply power to the PSUs A1-AN through the AC/DC converter 10. During this time, the switch S1 is turned off by the microprocessor 150. As a result, the current flowing from the AC/DC converter 10 flows through the resistor R1, such that the magnitude of the current flowing to the PSUs A1 to AN is decreased, avoiding damage to the PSUs A1 to AN.

When a preset time (in this embodiment, the preset time is 10.6 milliseconds) has elapsed, the capacitors C1 and C2 become fully charged, and the microprocessor 150 turns on the switch S1. As a result, the current flowing from the AC/DC converter 10 does not flow through the resistor R1. As a result, the resistor R1 does not consume energy.

The microprocessor 150 measures the current flowing through the current sensing resistor R2 and determines whether the measure current is greater than a maximum current which might possibly damage the server 1. When the measured current is greater than the maximum current, the microprocessor 150 turns off the switch S1. As a result, the current flowing from the AC/DC converter 10 flows through the resistor R1, such that the current flowing to the PSUs A1 to AN is decreased to avoid damage to the PSUs A1 to AN. When the measure current is not greater than the maximum current, the microprocessor 150 turns on the switch S1. As a result, the current flowing from the AC/DC converter 10 does not flow through the resistor R1. At this time, the resistor R1 does not consume energy.

In other embodiments, the switch S1 can be a relay, and the current sensing resistor R2 can be another element which can sense the current flowing from the AC/DC converter 10.

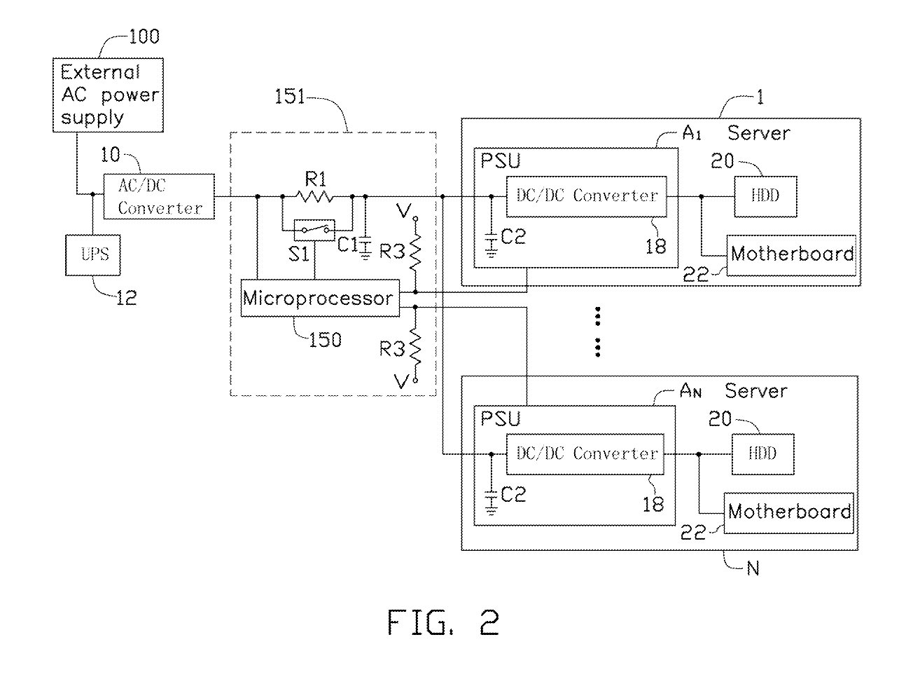

Referring to FIG. 2, differences between a power supply circuit of a second embodiment and the power supply circuit of the first embodiment are in the protection circuits. The protection circuit 151 of the second embodiment of the power supply circuit also includes a resistor R1, a switch S1, a capacitor C1, and a microprocessor 150.

A first terminal of the resistor R1 is connected to the AC/DC converter 10. A second terminal of the resistor R1 is connected to the PSUs A1-AN. The second terminal of the resistor R1 is grounded through the capacitor C1. The switch S1 is connected with the resistor R1 in parallel. The voltage sensing terminal of the microprocessor 150 is connected to the first terminal of the resistor R1. A ground pin of each of the PSUs A1-AN is connected to a signal sensing terminal of the microprocessor 150. The control terminal of the microprocessor 150 is connected to the switch S1. A node between each ground pin of the PSUs A1-AN and the corresponding signal sensing terminal is connected to a DC power supply V through a resistor R3.

Similar to the first embodiment, at the initial time when the external AC power supply 100 or the UPS 12 supplies power to the PSUs A1-AN of the servers, the microprocessor 150 turns off the switch S1. During this time, the current flowing from the AC/DC converter 10 flows through the resistor R1, such that the current flowing to the PSUs A1 to AN is decreased to avoid damage to the PSUs A1 to AN.

After a preset time (such as 10.6 milliseconds) has elapsed, the capacitors C1 and C2 become fully charged, and the microprocessor 150 turns on the switch S1. As a result, the current flowing from the AC/DC converter 10 does not flow through the resistor R1.

The microprocessor 150 determines whether any one of the PSUs A1-AN is not operating or is removed. If one PSU is removed, the signal sensing terminal connected to the ground pin of the removed PSU is idle. At this time, the signal sensing terminal of the microprocessor 150 receives a high level signal, and the microprocessor 150 determines that the PSU is not operating or removed. As a result, the microprocessor 150 turns off the switch S1. If one PSU is connected to the server, the signal sensing terminal is connected to the ground pin of the PSU. At this time, the signal sensing terminal of the microprocessor 150 receives a low level signal, and the microprocessor 150 determines that the PSU is connected to the server and operating. At this time, the capacitor C2 is charged. The microprocessor 150 turns off the switch S1. As a result, the current flowing from the AC/DC converter 10 flows through the resistor R1, such that the current flowing to the PSUs A1 to AN is decreased to avoid damage to the PSUs A1 to AN.

After the preset time has elapsed, the capacitor C2 is fully charged, the microprocessor 150 turns on the switch S1. As a result, the current flowing from the AC/DC converter 10 does not flow through the resistor R1.

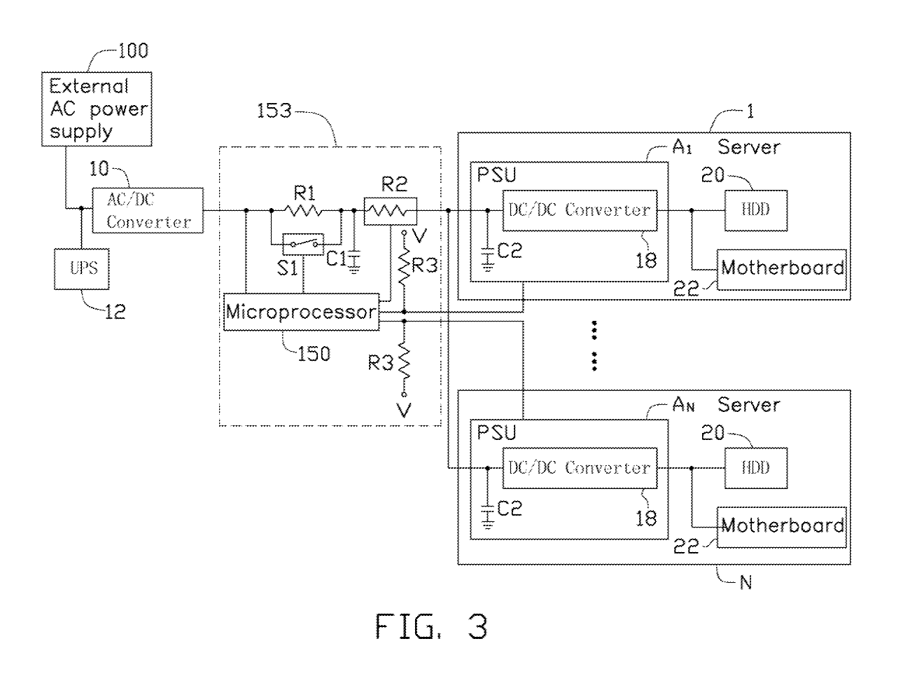

Referring to FIG. 3, differences between a third embodiment of a power supply circuit and the second embodiment of the power supply circuit are in the protection circuits. The protection circuit 153 of the third embodiment of the power supply circuit also includes a resistor R1, a switch S1, a capacitor C1, a current sensing resistor R2, and a microprocessor 150.

A first terminal of the resistor R1 is connected to the AC/DC converter 10. A second terminal of the resistor R1 is connected to the PSUs A1-AN through the current sensing resistor R2. A node between the resistor R1 and the current sensing resistor R2 is grounded through the capacitor C1. The switch S1 is connected with the resistor R1 in parallel. The voltage sensing terminal of the microprocessor 150 is connected to the first terminal of the resistor R1. The current sensing terminal of the microprocessor 150 is connected to the current sensing resistor R2. A ground pin of each of the PSUs A1-AN is connected to a single sensing terminal of the microprocessor 150. The control terminal of the microprocessor 150 is connected to the switch S1. A node between each ground pin of the PSUs A1-AN and the corresponding signal sensing terminal is connected to a DC power supply V through a resistor R3.

Similar with the first embodiment, when the voltage received by the protection circuit 153 is greater than zero, the microprocessor 150 will determine whether it is the external AC power supply 100 or the UPS 12 which will supply power to the PSUs A1-AN through the AC/DC converter 10. During this time, the switch S1 is turned off by the microprocessor 150. As a result, the current flowing from the AC/DC converter 10 flows through the resistor R1, such that the magnitude of the current flowing to the PSUs A1 to AN is decreased to avoid damage to the PSUs A1 to AN.

After a preset time (such as 10.6 milliseconds) has elapsed, the capacitors C1 and C2 become fully charged, and the microprocessor 150 turns on the switch S1. As a result, the current flowing from the AC/DC converter 10 does not flow through the resistor R1. As a result, the resistor R1 does not consume energy.

The microprocessor 150 measures the current flowing through the current sensing resistor R2 and determines whether the measure current is greater than a maximum current which might possible damage the server 1. Furthermore, the microprocessor 150 determines whether any one of the PSUs A1-AN is removed.

If the measure current is greater than the maximum current, the microprocessor 150 turns off the switch S1. As a result, the current flowing from the AC/DC converter 10 flows through the resistor R1, such that the current flowing to the PSUs A1 to AN is decreased to avoid damage to the PSUs A1 to AN. If the measure current is not greater than the maximum current, the microprocessor 150 turns on the switch S1. As a result, the current flowing from the AC/DC converter 10 does not flow through the resistor R1. At this time, the resistor R1 does not consume energy.

If any one of the PSUs A1-AN is removed, the signal sensing terminal connected to the ground pin of the removed PSU is idle. At this time, the signal sensing terminal of the microprocessor 150 receives a high level signal, and the microprocessor 150 determines that the PSU is removed. As a result, the microprocessor 150 turns off the switch S1. If one PSU is connected to the server, the signal sensing terminal is connected to the ground pin of the PSU. At this time, the signal sensing terminal of the microprocessor 150 receives a low level signal, and the microprocessor 150 determines that the PSU is connected to the server and operating. At this time, the capacitor C2 is charged. The microprocessor 150 turns off the switch S1. As a result, the current flowing from the AC/DC converter 10 flows through the resistor R1, such that the current flowing to the PSUs A1 to AN is decreased to avoid damage to the PSUs A1 to AN.

After the preset time has elapsed, the capacitor C2 is fully charged, the microprocessor 150 turns on the switch S1. As a result, the current flowing from the AC/DC converter 10 does not flow through the resistor R1.

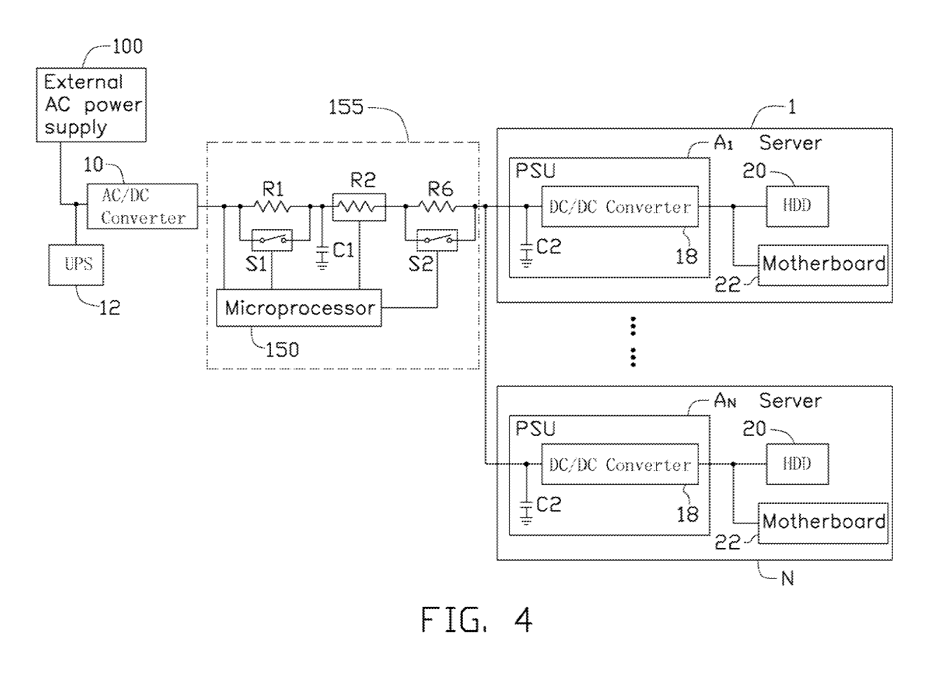

Referring to FIG. 4, differences between a fourth embodiment of a power supply circuit and the first embodiment of the power supply circuit are in the protection circuits. In the fourth embodiment of the power supply circuit, the protection circuit 155 also includes resistors R1 and R6, switches S1 and S2, a capacitor C1, a current sensing resistor R2, and a microprocessor 150.

A first terminal of the resistor R1 is connected to the AC/DC converter 10. A second terminal of the resistor R1 is connected to the PSUs A1-AN through the current sensing resistor R2 and the resistor R6 in series. A node between the resistor R1 and the current sensing resistor R2 is grounded through the capacitor C1. The switch S1 is connected to the resistor R1 in parallel. The switch S2 is connected to the resistor R6 in parallel. The control terminal of the microprocessor 150 is connected to the switches S1 and S2.

Similar with the first embodiment, when the voltage received by the protection circuit 155 is greater than zero, the microprocessor 150 determines that the external AC power supply 100 or the UPS 12 supplies power to the PSUs A1-AN through the AC/DC converter 10. At this time, the microprocessor 150 turns off the switches S1 and S2. As a result, the current flowing from the AC/DC converter 10 flows through the resistors R1 and R6, such that the current flowing to the PSUs A1 to AN is decreased to avoid damage to the PSUs A1 to AN.

After a preset time (such as 10.6 milliseconds) has elapsed, the capacitors C1 and C2 become fully charged, and the microprocessor 150 turns on the switches S1 and S2. As a result, the current flowing from the AC/DC converter 10 does not flow through the resistors R1 and R6.

The microprocessor 150 measures the current flowing through the current sensing resistor R2 and determines whether the measure current is greater than a maximum current. If the measure current is greater than the maximum current, the microprocessor 150 turns off the switches S1 and S2. As a result, the current flowing from the AC/DC converter 10 flows through the resistors R1 and R6, such that the current flowing to the PSUs A1 to AN is decreased to avoid damage to the PSUs A1 to AN. If the measure current is not greater than the maximum current, the microprocessor 150 turns on the switches S1 and S2. As a result, the current flowing from the AC/DC converter 10 does not flow through the resistors R1 and R6.

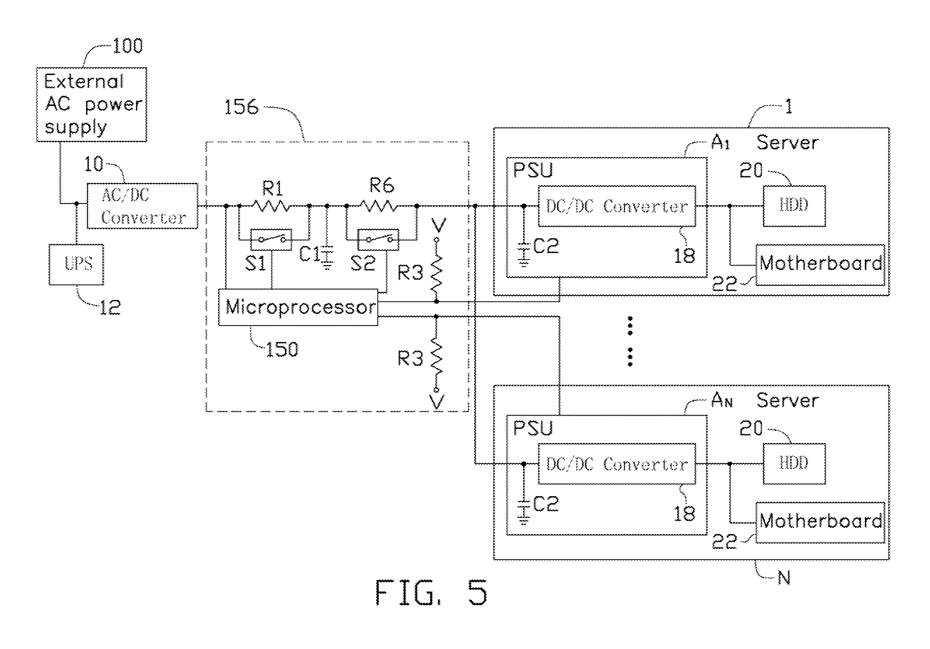

Referring to FIG. 5, differences between a fifth embodiment of a power supply circuit and the second embodiment of the power supply circuit are in the protection circuits. In the fifth embodiment of the power supply circuit, a protection circuit 156 also includes resistors R1 and R6, switches S1 and S2, a capacitor C1, and a microprocessor 150.

A first terminal of the resistor R1 is connected to the AC/DC converter 10. A second terminal of the resistor R1 is connected to the PSUs A1-AN through the resistor R6. A node between the resistors R1 and R6 is grounded through the capacitor C1. The switch S1 is connected to the resistor R1 in parallel. The switch S2 is connected to the resistor R6 in parallel. The voltage sensing terminal of the microprocessor 150 is connected to the first terminal of the resistor R1. A ground pin of each of the PSUs A1-AN is connected to a signal sensing terminal of the microprocessor 150. The control terminal of the microprocessor 150 is connected to the switches S1 and S2. A node between each ground pin of the PSUs A1-AN and the corresponding signal sensing terminal is connected to a DC power supply V through a resistor R3.

Similar to the first embodiment, at the initial time when the external AC power supply 100 or the UPS 12 supplies power to the PSUs A1-AN of the servers, the microprocessor 150 turns off the switches S1 and S2. At this time, the current flowing from the AC/DC converter 10 flows through the resistors R1 and R6, such that the current flowing to the PSUs A1 to AN is decreased to avoid damage to the PSUs A1 to AN.

After a preset time (such as 10.6 milliseconds) has elapsed, the capacitors C1 and C2 become fully charged, and the microprocessor 150 turns on the switches S1 and S2. As a result, the current flowing from the AC/DC converter 10 does not flow through the resistors R1 and R6.

The microprocessor 150 determines whether any one of the PSUs A1-AN is removed. If one PSU is removed, the signal sensing terminal connected to the ground pin of the removed PSU is idle. At this time, the signal sensing terminal of the microprocessor 150 receives a high level signal, and the microprocessor 150 determines that the PSU is removed. As a result, the microprocessor 150 turns off the switches S1 and S2. If one PSU is connected to the server, the signal sensing terminal is connected to the ground pin of the PSU. At this time, the signal sensing terminal of the microprocessor 150 receives a low level signal, and the microprocessor 150 determines that the PSU is connected to the server. At this time, the capacitor C2 becomes charged. The microprocessor 150 turns off the switches S1 and S2. As a result, the current flowing from the AC/DC converter 10 flows through the resistors R1 and R6, such that the current flowing to the PSUs A1 to AN is decreased to avoid damage to the PSUs A1 to AN.

After the preset time has elapsed, the capacitor C2 becomes fully charged, the microprocessor 150 turns on the switches S1 and S2. As a result, the current flowing from the AC/DC converter 10 does not flow through the resistors R1 and R6. At this time, the resistors R1 and R6 do not consume power energy.

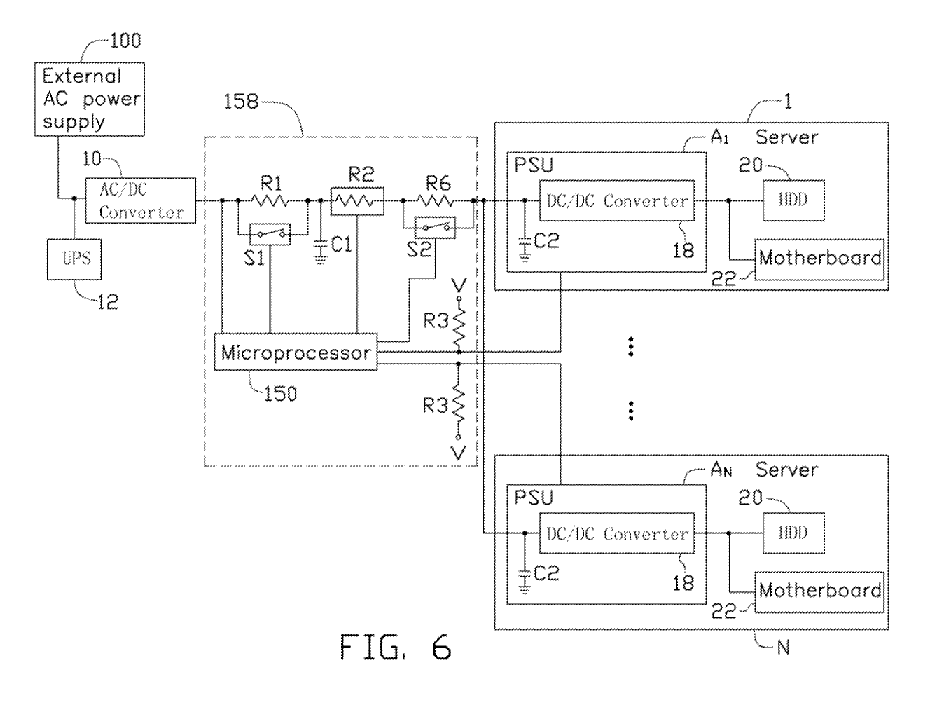

Referring to FIG. 6, differences between a sixth embodiment of a power supply circuit and the third embodiment of the power supply circuit are in the protection circuits. In the sixth embodiment of the power supply circuit, a protection circuit 158 includes resistors R1 and R6, switches S1 and S2, a capacitor C1, a current sensing resistor R2, and a microprocessor 150.

The first terminal of the resistor R1 is connected to the AC/DC 10. The second terminal of the resistor R1 is connected to the PSUs A1-AN through the current sensing resistor R2 and the resistor R6 in series. A node between the resistor R1 and the current sensing resistor R2 is grounded through the capacitor C1. The switch S1 is connected to the resistor R1 in parallel. The switch S2 is connected to the resistor R6 in parallel. The voltage sensing terminal of the microprocessor 150 is connected to the first terminal of the resistor R1. The current sensing terminal of the microprocessor 150 is connected to the current sensing resistor R2. A ground pin of each of the PSUs A1-AN is connected to a signal sensing terminal of the microprocessor 150. The control terminal of the microprocessor 150 is connected to the switches S1 and S2. A node between each ground pin of the PSUs A1-AN and the corresponding signal sensing terminal is connected to a DC power supply V through a resistor R3.

Similar with the third embodiment, when the voltage received by the protection circuit 153 is greater than zero, the microprocessor 150 determines that the external AC power supply 100 or the UPS 12 supplies power to the PSUs A1-AN through the AC/DC converter 10. During this time, the microprocessor 150 turns off the switches S1 and S2. As a result, the current flowing from the AC/DC converter 10 flows through the resistors R1 and R6, such that the current flowing to the PSUs A1 to AN is decreased to avoid damage to the PSUs A1 to AN.

After a preset time (such as 10.6 milliseconds) has elapsed, the capacitors C1 and C2 become fully charged, and the microprocessor 150 turns on the switches S1 and S2. As a result, the current flowing from the AC/DC converter 10 does not flow through the resistors R1 and R6. At this time, the resistor R1 does not consume power energy.

The microprocessor 150 measures the current flowing through the current sensing resistor R2 and determines whether the measure current is greater than a maximum current. Furthermore, the microprocessor 150 determines whether any one of the PSUs A1-AN is removed.

If the measure current is greater than the maximum current, the microprocessor 150 turns off the switches S1 and S2. As a result, the current flowing from the AC/DC converter 10 flows through the resistors R1 and R6, such that the current flowing to the PSUs A1 to AN is decreased to avoid damage to the PSUs A1 to AN. If the measure current is not greater than the maximum current, the microprocessor 150 turns on the switches S1 and S2. As a result, the current flowing from the AC/DC converter 10 does not flow through the resistors R1 and R6. At this time, the resistors R1 and R6 do not consume power energy.

If one PSU is removed, the signal sensing terminal connected to the ground pin of the removed PSU is idle. At this time, the signal sensing terminal of the microprocessor 150 receives a high level signal, and the microprocessor 150 determines that the PSU is removed. As a result, the microprocessor 150 turns off the switches S1 and S2. If one PSU is connected to the server, the signal sensing terminal is connected to the ground pin of the PSU. At this time, the signal sensing terminal of the microprocessor 150 receives a low level signal, and the microprocessor 150 determines that the PSU is connected to the server. At this time, the capacitor C2 is charged. The microprocessor 150 turns off the switches S1 and S2. As a result, the current flowing from the AC/DC converter 10 flows through the resistors R1 and R6, such that the current flowing to the PSUs A1 to AN is decreased to avoid damage to the PSUs A1 to AN.

After the preset time has elapsed, the capacitor C2 becomes fully charged, the microprocessor 150 turns on the switches S1 and S2. As a result, the current flowing from the AC/DC converter 10 does not flow through the resistors R1 and R6. At this time, the resistors R1 and R6 do not consume power energy.

The foregoing description of the exemplary embodiments of the disclosure has been presented only for the purposes of illustration and description and is not intended to be exhaustive or to limit the disclosure to the precise forms disclosed. Many modifications and variations are possible. The embodiments were chosen and described in order to explain the principles of the disclosure and their practical application so as to enable others of ordinary skill in the art to utilize the disclosure and various embodiments and with such modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than by the foregoing description and the exemplary embodiments described therein.

What is claimed is:

1. A power supply circuit, comprising:
an uninterruptible power supply (UPS);
an alternating current to direct current (AC/DC) converter connected to the UPS, for converting AC power from the UPS to DC power; and
a protection circuit connected to the AC/DC converter, to receive the DC power, the protection circuit comprising a first resistor, a first switch, a first capacitor, and a microprocessor;
wherein a first terminal of the first resistor is connected to the AC/DC converter, a second terminal of the first resistor is connected to the PSU, the second terminal of the first resistor is further grounded through the first capacitor, the first switch is connected to the first resistor in parallel, a voltage sensing terminal of the microprocessor is connected to the first terminal of the first resistor, a control terminal of the microprocessor is connected to the first switch, wherein at the initial time when the UPS supplies power to the UPS, the microprocessor turns off the first switch; after a preset time has elapsed, the microprocessor turns on the first switch.

2. The power supply circuit of claim 1, wherein the PSU comprises a DC to DC (DC/DC) converter, the DC/DC converter is connected to the protection circuit to receive the DC power from the protection circuit and converts the DC power to other DC power with different voltages.

3. The power supply circuit of claim 1, further comprising an external AC power supply connected to the AC/DC converter, wherein the AC/DC converter converts AC power from the external AC power supply to DC power and transmits the DC power to the PSU through the protection circuit.

4. The power supply circuit of claim 1, further comprising a current sensing resistor, wherein the PSU comprises a second capacitor, the second terminal of the first resistor is connected to the PSU through the current sensing resistor, a terminal of the current sensing resistor connected to the PSU is grounded through the second capacitor, a current sensing terminal of the microprocessor is connected to the current sensing resistor for receiving the current flowing through the current sensing resistor; when the current flowing through the current sensing resistor is greater than a preset current, the microprocessor turns on the first switch; when the current flowing through the current sensing resistor is not greater than the preset current, the microprocessor turns off the first switch.

5. The power supply circuit of claim 4, wherein the protection circuit further comprises a second resistor and a second switch, the second resistor is connected between the current sensing resistor and the PSU, the second switch is connected to the second resistor in parallel, the second switch is further connected to a control terminal of the microprocessor; when the current flowing through the current sensing resistor is greater than the preset current, the microprocessor further turns on the second switch; when the current flowing through the current sensing resistor is not greater than the preset current, the microprocessor further turns off the second switch.

6. The power supply circuit of claim 4, wherein the PSU comprises a second capacitor, the second terminal of the first resistor is grounded through the second capacitor, a signal sensing terminal of the microprocessor is connected to a ground pin of the PSU, a node between the signal sensing terminal of the microprocessor and the ground pin of the PSU is connected to a DC power through a second resistor; at the initial time when the PSU is connected to the protection circuit, the microprocessor turns off the first switch, after a preset time has elapsed, the microprocessor turns on the first switch.

7. The power supply circuit of claim 6, wherein the protection circuit further comprises a third resistor and a second switch, the third resistor is connected between the current sensing resistor and the PSU, the second switch is connected to the third resistor in parallel, the second switch is further connected to the control terminal of the microprocessor; at the initial time when the PSU is connected to the protection circuit, the microprocessor further turns off the second switch, after the preset time has elapsed, the microprocessor further turns on the second switch.

8. The power supply circuit of claim 1, wherein the PSU comprises a second capacitor, the second terminal of the first resistor is further grounded through the second capacitor, a signal sensing terminal of the microprocessor is connected to a ground pin of the PSU, a node between the signal sensing terminal of the microprocessor and the ground pin of the PSU is connected to a DC power through a second resistor; at the initial time when the PSU is connected to the protection circuit, the microprocessor turns off the first switch, after a preset time has elapsed, the microprocessor turns on the first switch.

9. The power supply circuit of claim 8, wherein the protection circuit further comprises a third resistor and a second switch, the third resistor is connected between the current sensing resistor and the PSU, the second switch is connected to the third resistor in parallel, the second switch is further connected to a control terminal of the microprocessor; at the initial time when the PSU is connected to the protection circuit, the microprocessor further turns off the second switch, after the preset time has elapsed, the microprocessor further turns on the second switch.

10. The power supply circuit of claim 1, wherein the preset time is 10.6 milliseconds.
